(19) United States
(12) Patent Application Publication
(10) Pub. No.: US 2024/0162408 A1
(43) Pub. Date: May 16, 2024

(54) METHOD AND DEVICE FOR PRODUCING A DRY FILM

(71) Applicant: Volkswagen Aktiengesellschaft, Wolfsburg (DE)

(72) Inventors: Ludger BUSSWINKEL, Braunschweig (DE); Sebastian REUBER, Dresden (DE); Roland SCHMIDT-LOBACH, Hoersingen (DE); Sven SCHOPF, Braunschweig (DE)

(73) Assignee: Volkswagen Aktiengesellschaft, Wolfsburg (DE)

(21) Appl. No.: 18/388,380

(22) Filed: Nov. 9, 2023

(30) Foreign Application Priority Data
Nov. 11, 2022 (DE) 10 2022 211 993.2

(51) Int. Cl. H01M 4/04

(52) U.S. Cl. CPC H01M 4/0435

(57) ABSTRACT

A device for producing a dry film, in particular an electrode layer. The device has a roller apparatus with a first roller and with a second roller for forming the dry film from a dry film material charge, as well as a doctor blade, which is movable to regulate a height of the dry film material charge. In addition, a method is provided for producing a dry film, in particular, by the device.

This nonprovisional application claims priority under 35 U.S.C. § 119(a) to German Patent Application No. 10 2022 211 993.2, which was filed in Germany on Nov. 11, 2022, and which is herein incorporated by reference.

### BACKGROUND OF THE INVENTION

### Field of the Invention

The invention relates to a device and a method for producing a dry film, in particular an electrode layer.

### Description of the Background Art

As is known from WO 2018/210723 A1, which corresponds to US 2021/0320288, for example, a dry film material is conveyed between two rollers of a rolling device by means of a powder conveyor to produce a dry film. Compressive and/or shear forces are introduced into the dry film material by means of these rollers so that the dry film forms.

For the most homogeneous possible properties of the dry film, however, the dry film material should be distributed correspondingly uniformly in the nip between the rollers in this process. For example, the dry film material is conveyed uniformly in space and time between the rollers for this purpose.

### SUMMARY OF THE INVENTION

It is therefore an object of the invention is to provide an especially suitable method and/or an especially suitable device for producing a dry film. In particular, a homogeneity of the dry film thus produced should be improved by this means.

In an exemplary embodiment, the device is equipped for producing a dry film from dry film material. The dry film is usefully an electrode layer (an electrode film), in particular for an electrode of a lithium-ion battery. For example, subsequent to its production by means of the device, the electrode layer is joined to a current collector foil, for example laminated thereto.

The dry film material in this case is usefully a granular material also referred to as granulate, for example a powder or a powder mixture.

The device includes a roller apparatus with a first roller and with a second roller, which form a roller pair. The rotational axes of the first roller and of the second roller extend parallel to one another in a suitable manner, wherein the direction in which the two rotational axes extend is also referred to hereinbelow as the axial direction. A roll nip is formed between the first and second rollers.

The two rollers serve in this case to form the dry film from a dry film material charge. For this purpose, processing is done on the dry film material of the dry film material charge by means of the rollers, in particular a pressing force and/or a shear force on the dry film material is created so that the particles of the dry film material bond to one another.

During the course of producing the dry film, the dry film material, in particular solvent-free dry film material, is conveyed, in particular poured, into the roll nip. This material accumulates in the roll nip ahead of its narrowest point. Consequently, a buildup of material forms in the roll nip. The “dry film material charge” is to be understood as this accumulation of dry film material that is located in the roll nip.

In addition, the invention includes a doctor blade. This blade is equipped to regulate the height of the dry film material charge (material charge), or in other words to regulate its extent in a direction perpendicular to the plane that is spanned by the rotational axes of the first and second rollers. For this purpose, the doctor blade is movable, preferably automatically movable.

It is made possible by means of the doctor blade to remove, in particular scrape off, dry film material from the dry film material charge. Accordingly, the dry film material charge has a defined height. A precompression of the dry film material on account of a comparatively great height of the dry film material charge is advantageously prevented in this way. On the one hand, a homogeneity of the dry film produced, in particular of its density, is increased especially advantageously as a consequence thereof. On the other hand, an associated increase in the torque of a roller drive, or even a jamming of the roller drive, on account of this precompression is prevented.

The doctor blade can be movable in a direction parallel to the rotational axes of the first roller and/or of the second roller, which is to say in the axial direction. The dry film material removed via the doctor blade is thus conveyed to the ends of the rollers with respect to the axial direction. A collecting device for the removed dry film material is provided at the axial ends of the rollers, for example.

The doctor blade can be designed such that at least its end on the nip side is movable in the roll nip, hence in a region between the first and second rollers. Consequently, a defined height of the dry film material that is smaller than the radius of the first and/or second roller can be and/or is regulated.

A travel speed of the doctor blade can be adjustable and/or controllable. In addition or alternatively hereto, a distance of the doctor blade from the rollers, in particular the distance between the doctor blade and the plane spanned by the rotational axes of the rollers also referred to as doctor blade height, is adjustable. Preferably, the doctor blade can be inclined against the axial direction.

Advantageously, the device can be adjusted in this way for the production of dry films with different material compositions and/or densities.

One shield element each may be provided for the first roller and for the second roller. Therefore, a first of the shield elements is associated with the first roller and a second of the shield elements is associated with the second roller. The two shield elements in this case are arranged between the first and second rollers, in particular in the roll nip. Preferably, the shield elements are arranged in the circumferential region of the relevant associated roller. The two shield elements are arranged spaced apart from one another. The region between them thus forms a receiving area for the dry film material charge. In other words, the two shield elements delimit the region in which the dry film material accumulates. Expediently, the two shield elements do not extend to the narrowest point of the roll nip. Expediently, the two shield elements are stationary, which is to say they do not rotate together with the rollers.

The dry film material is thus conveyed into the receiving area, in particular solely into the receiving area, during production of the dry film.

Contact of the dry film material is prevented in the region of the roller circumference where the respective shield element is located. The dry film material is thus processed by means of the rollers only in a defined region.

Expediently, the doctor blade can move in the receiving area, which is to say between the two shield elements. Consequently, contact between the doctor blade and the rollers, and thus a concomitant damage to the doctor blade and/or the rollers, is prevented.

The device can have a vibrating unit for the shield elements. This unit serves to shake the shield elements, in particular to set them in vibration, in order to prevent an unwanted adhesion of the dry film material to them.

The shield elements can be designed in the shape of a circular arc in a space-saving manner, wherein they are usefully arranged concentrically to the respective roller.

The shield elements can be designed such that their sides that face one another, which is to say the sides that delimit the receiving area, are flat and/or inclined toward one another. In particular, the receiving area has a wedge-shaped or trapezoidal cross-section in a plane perpendicular to the axial direction. If need be, the risk of adhesion of the dry film material to the respective shield element and/or the formation of a so-called dead zone, in which the dry film material remains static, is advantageously reduced in this way.

The side of the respective shield element facing the rollers can be designed in the shape of a circular arc and can be arranged concentrically to the respective associated roller. Consequently, material scraped off by means of the doctor blade is prevented from unwanted entry between the shield element and the roller associated therewith.

The shield elements can have different distances from the (center) plane spanned by means of the rotational axes of the first and second rollers. In other words, the region in the roll nip that is not shielded, in particular covered, for one of the rollers by its associated shield element is larger than is the case for the other roller. Consequently, the shield elements are arranged asymmetrically in the roll nip.

If the shield elements are circular arc-shaped, then the central angles of the shield elements are different sizes, for example.

Such an asymmetrical design can, in particular, result in better feed characteristics of the dry film material into the roll nip, depending on the composition and/or embodiment of the dry film material. Furthermore, an installation space required in the roll nip for the shield element is reduced as compared to the symmetrical design of the shield elements on account of the greater distance of the corresponding shield element from the center plane.

In particular, an action of force, in particular an action of shear force, on the dry film material can be influenced in this way.

Another aspect of the invention relates to a method for producing a dry film, in particular an electrode layer. Preferably, a device according to one of the above-described variants is used for this.

According to the method, dry film material, which expediently is a granular material, in this case is conveyed, in particular poured, between the first roller and the second roller with formation of a dry film material charge. The dry film material in this case is solvent-free and/or dry, in particular.

Furthermore, according to the method, dry film material is removed from the dry film material charge in such a manner that a predetermined (fill) height of the dry film material charge is regulated. Expediently, the doctor blade is moved for this purpose, preferably within the roll nip and/or in the axial direction. In the method, dry film material, in particular the dry material that is located above the predetermined height, is removed from the roll nip by the doctor blade. A defined height of the dry film material charge is advantageously achieved as a result.

Expediently, the doctor blade can be moved continuously, in particular without interruption over time.

Expediently, the rollers rotate continuously in the process, in particular with a constant rotational speed, so that the dry film is produced by means of the rollers from the dry film material of the dry film material charge. In this process, particles of the dry film material charge bond together on account of the shear load and/or compressive load in the nip.

For uniform removal of the excess dry film material, the doctor blade expediently is moved in the axial direction at a constant speed and/or opposite the axial direction at a constant speed.

Dry film material can be continuously conveyed into the roll nip, which is to say replenished, preferably at a constant dispensing rate. This results in a comparatively homogeneous distribution of dry film material in the roll nip.

Further, the dispensing rate of dry film material can be set in such a manner that the material does not fall below the predetermined height. In other words, the dispensing rate, which is to say the rate at which the dry film material is supplied to the roller apparatus, is greater than a rate of material that is conveyed out of the roller apparatus as dry film. In this way, an underfilling and an uneven formation of the dry layer associated therewith is advantageously prevented.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a device for producing a dry film in a side view, wherein the device includes a doctor blade and a roller apparatus with a first and second roller, and wherein a shield element for each of the rollers is arranged in the roll nip,

FIG. 2 schematically shows the device in a top view,

FIG. 3 schematically shows a variant of the device in a side view, wherein this variant has a vibrating unit for the shield elements,

FIG. 4 schematically shows a variant of the device in a side view, wherein its rollers have different diameters,

FIG. 5 schematically shows a variant of the device in a side view, wherein sides of the shield elements that face one another are flat in design and are inclined relative to one another,

FIG. 6 schematically shows a variant of the device in a side view, according to which the shield elements are designed asymmetrically, and

FIG. 7 shows, by means of a flow chart, a method for producing a dry film in which dry film material is removed from the roll nip by means of the doctor blade.

### DETAILED DESCRIPTION

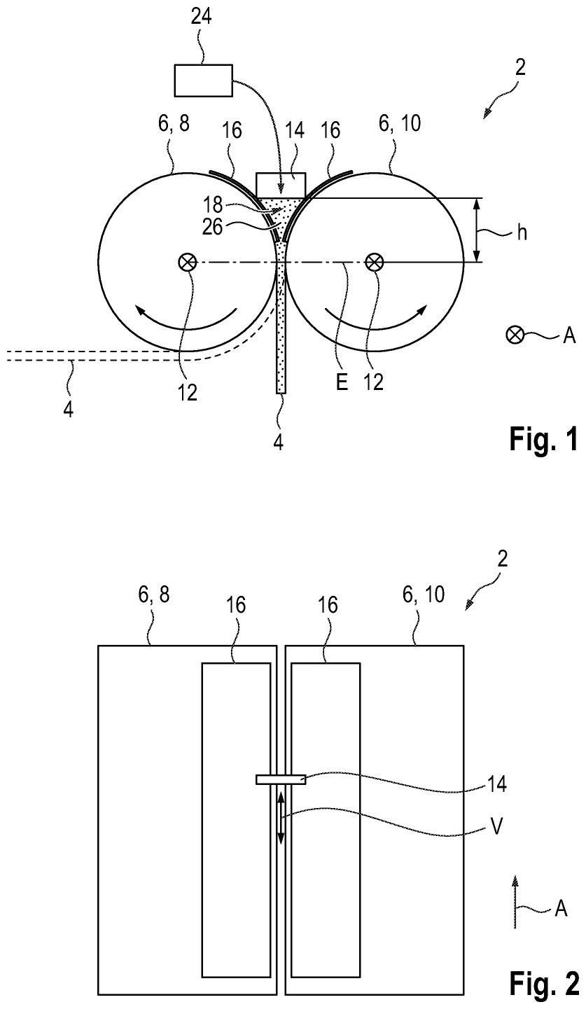

Variants of a device 2 that is equipped for producing a dry film 4, in particular an electrode layer for an electrode of a lithium-ion battery, from dry film material are shown schematically in FIGS. 1 to 6. The dry film material in this case is a solvent-free and dry granular medium, for example a powder.

Common to all variants is that the device 2 includes a roller apparatus 6 with a first roller 8, in particular calender roller, and with a second roller 10, in particular calender roller, wherein the rotational axes 12 of these two rollers 8, 10 extend parallel to one another and in a direction labeled as axial direction A.

A doctor blade 14 is arranged at least partially in the roll nip. In other words, the doctor blade 14 projects into the spatial region between the two rollers 8 and 10. Expressed in yet another way, the distance of the doctor blade 14 from the plane E that is spanned by the two rotational axes 12 of the rollers 8, 10 is smaller than the radius of the two rollers 8, 10. This plane is also referred to hereinbelow as center plane E. The doctor blade 14 can move parallel to the axial direction A in this case.

The “roll nip” can be understood here as the spatial region between the two rollers 8 and 10 and between those planes that are parallel to the center plane E and whose distance from the center plane E is equal to the radius of the two rollers 8, 10. In the case of rollers 8, 10 with different radii (see FIG. 4), the roll nip is to be understood as the spatial region between the two rollers 8 and 10 and between those planes that are parallel to the center plane E and whose distance from the center plane E is equal to the smaller of the two radii of the rollers 8, 10.

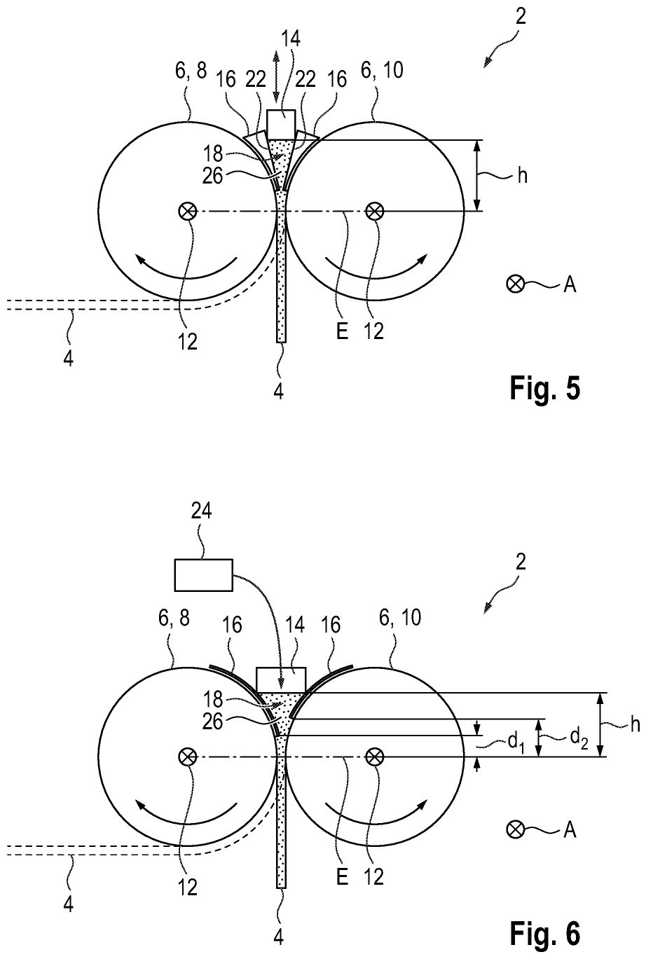

The travel speed V of the doctor blade 14 and/or a distance of the doctor blade 14 from the rollers, in particular from the center plane E, is adjustable, which is represented by way of example in FIG. 2 and in FIGS. 4 and 5 by means of a double-headed arrow in each case.

The device 2 includes a shield element 16 for the first roller 8 and another shield element 16 for the second roller 10. These are each arranged circumferentially relative to the associated roller 8 or 10, respectively, and in the roll nip, hence between the two rollers 8, 10. The two shield elements 16 delimit a receiving area 18 for the dry film material. The shield elements 16 in this case are arranged solely on one side of the center plane E and spaced apart therefrom.

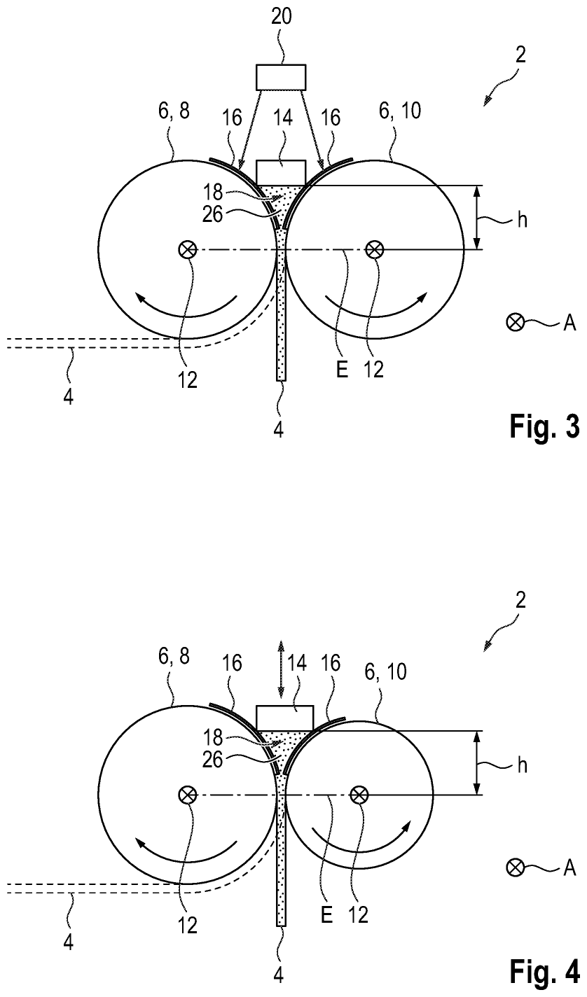

According to the variant of the device 2 shown in FIG. 3, the device includes a vibrating unit 20 that is coupled to the two shield elements 16, which is schematically represented by means of an arrow in each case. The vibrating unit 20 is provided for the purpose of shaking the shield elements 16, for example in that it strikes the shield elements 16. Consequently, adhesion of the dry film material to the shield elements 16 is prevented.

According to the variants shown in FIGS. 1 to 4 and 6, the shield elements 16 are each designed in the shape of a circular arc and arranged concentrically to the respective associated roller 8 or 10. In this way, the receiving area 18 is made comparatively large.

In the variant of the device 2 shown in FIG. 4, the two rollers 8, 10 have different diameters.

In the variant of the device 2 shown in FIG. 5, the sides 22 that face one another, which is to say the sides 22 that delimit the receiving area 18, are flat and inclined toward one another. Consequently, a receiving area 18 is formed that tapers toward the center plane. The sides in this case form a comparatively large angle to the center plane E, thus preventing an adhesion of the dry film material to the respective shield element 16 and/or the formation of a dead zone.

The side of the respective shield element 16 facing the roller 8 or 10, respectively, is designed in the shape of a circular arc and arranged concentrically to the respective associated roller 8 or 10. The shield elements 16 thus extend between the receiving area 18 and the respective roller 8 or 10. Consequently, unwanted entry of dry film material between the respective shield element 16 and the respective roller 8, 10 is prevented.

In the variant of the device 2 shown in FIG. 6, the two shield elements 16 are arranged in the roll nip in such a way that the distance d₁ of the shield element 16 associated with the first roller 8 from the center plane E is smaller than the distance d₂ of the shield element 16 associated with the second roller 10 from the center plane E.

The device 2 according to all variants additionally has a material conveyor 24, which is shown only in FIG. 1 and FIG. 6 for the purpose of better clarity. The material conveyor 24 serves to convey dry film material into the receiving area 18 between the shield elements 16.

The dry film material accumulating in the receiving area is referred to as dry film material charge and is labeled with reference symbol 26 in the figures. In the figures, the dry film material of the dry film charge 26, and the dry film material processed into dry film by means of the rollers 8, 10, are shown as dotted areas.

The doctor blade 14 serves to regulate a defined height h of the dry film material charge 26, which is to say the extent of the dry film material charge 26 from the center plane E. For this purpose, the doctor blade 14 moves and removes dry film material of the dry film material charge 26. An overfilling, and an associated precompression of the dry film material in the dry film material charge 26, is prevented in this way.

Expediently, the device 2 in this case is oriented such that the dry film charge 26 is located above the center plane E with respect to the direction of gravity.

The edge of the doctor blade 14 facing the center plane E is shown as straight in the figures. According to variants that are not shown, the edge is curved in design. Optionally, the doctor blade 14 can be inclined against the axial direction A in a manner that is not shown in detail.

In the case of all variants of the device 2, the first roller 8 and/or the second roller 10 are optionally heatable.

In the case of all variants of the device 2, the magnitude of the rotational speed (angular speed, speed of rotation) of the two rollers 8, 10 is chosen to be either equal or different from one another. For example, a rotation of the rollers 8 and 10 with equal magnitude of the rotational speed and with equal diameter is especially suitable for producing a so-called freestanding dry film 4, which is to say that the dry film 4 produced by means of the rollers 8, 10 is not carried on the rollers 8, 10.

Alternatively, an action of shear force on the dry film material is increased in the case of different rotational speeds and/or in the case of equal rotational speed but different diameters of the rollers 8, 10. Moreover, this variant is especially suitable for a so-called roller-supported dry film 4, in which the dry film 4 that is produced is carried on one of the two rollers 8, 10, and thus is deflected. The roller-supported dry film 4 is shown in dashed lines in the figures.

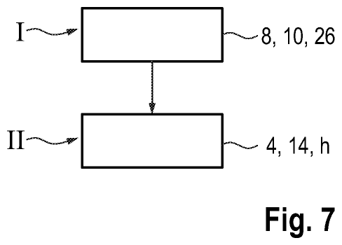

A flowchart that represents a method for producing the dry film 4 is shown in FIG. 7. The method is carried out, in particular, by means of the device 2 in one of the above-described variants.

In a first step I, dry film material is conveyed, in particular by means of the material conveyor 24, between the first and second rollers 8, 10, in particular into the receiving area 18 formed between the shield elements 16. In this process, the dry film material accumulates while forming the dry film material charge 26.

In a second step II, dry film material is removed from the dry film material charge 26 by means of the doctor blade 14 so that the predetermined height h of the dry film material charge 26 is regulated. In particular, the doctor blade 14 is moved in the roll nip, preferably in and/or opposite the axial direction, for this purpose. In doing so, the doctor blade 14 carries dry film material along, or in other words scrapes it off of the dry film material charge 26, so that the dry film material charge continues to have the height h.

The two are rollers 8, 10 that rotated, expediently with a constant rotational speed. In this process, the dry film 4 is created, which is to say produced, from the dry film material of the dry film material charge 26.

Moreover, the dry film material is expediently conveyed between the rollers 8, 10, preferably continuously, as in without interruption, and/or preferably at a constant dispensing rate (conveying rate).

Further preferably, the dispensing rate is set such that an underfilling is prevented. In other words, the dispensing rate is set such that the dry film charge 26 does not fall below the height h on account of the material consumption for the production of the dry film 4 and/or on account of the removal of the dry film material by means of the doctor blade 14.

The invention is not limited to the above-described exemplary embodiments. Instead, other variants of the invention can also be derived herefrom by the person skilled in the art within the scope of the claims without departing from the subject matter of the invention. Moreover, all individual features described in connection with the exemplary embodiments and/or in the claims can, in particular, also be combined with one another in other ways without departing from the subject matter of the invention.

What is claimed is:

1. A device to produce a dry film, in particular an electrode layer, the device comprising:
a roller apparatus with a first roller and a second roller to form the dry film from a dry film material charge; and
a doctor blade that is movable to regulate a height of the dry film material charge.

2. The device according to claim 1, wherein a shield element is provided for each of the first roller and for the second roller, wherein the shield elements are arranged between the first roller and the second roller, and wherein a receiving area for the dry film material charge is formed by the shield elements.

3. The device according to claim 2, further comprising a vibrating unit for the shield element.

4. The device according to claim 2, wherein the shield elements are designed in a shape of a circular arc.

5. The device according to claim 2, wherein sides of the shield elements that face one another are flat and/or inclined toward one another.

6. The device according to claim 2, wherein the shield elements have different distances from a plane spanned by the rotational axes of the first and second rollers.

7. The device according to claim 1, wherein a travel speed of the doctor blade and/or a distance of the doctor blade from the rollers of the roller apparatus is adjustable.

8. The device according to claim 1, wherein the doctor blade is movable in a direction parallel to the rotational axis of the first roller and/or of the second roller, and/or wherein the doctor blade is movable in a roll nip formed between the first roller and the second roller.

9. A method to produce a dry film by a device in accordance with claim 1, the method comprising:
conveying dry film material between a first roller and a second roller via a formation of a dry film material charge; and
removing the dry film material from the dry film material charge via the doctor blade so that a predetermined height of the dry film material charge is regulated.

10. The method according to claim 9, wherein the dry film material is replenished continuously, and/or wherein a dispensing rate of dry film material is set in such a manner that the dry film material charge does not fall below the predetermined height.
